(19) United States
(12) Patent Application Publication
(10) Pub. No.: US 2006/0068727 A1
(43) Pub. Date: Mar. 30, 2006

(54) Method and system for dynamic range power control

(75) Inventor: Raul Salvi, Boca Raton, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/955,431

(22) Filed: Sep. 30, 2004

(51) Int. Cl. H01Q 11/12

(52) U.S. Cl. 455/127.2

(57) ABSTRACT

A system for current efficient dynamic power range control in a transmitter lineup (10) can include a switched mixer (18) coupled to a switched step attenuator (20) and a switched power driver (22) coupled to the switched step attenuator. Linearity and efficiency can be substantially maintained for more than 70 dB of dynamic power range for the system. The dynamic power range control can all occur within the radio frequency range and current can be dynamically switched along with the output power. The transmitter can allow for over 30 dB of continuous power control and over 45 dB of discrete power control. The switched power driver can further include continuous power control via a stacked current steer (202) and stepped power control via a current switched IQ summer amplifier (204, 206, 208, 209, 214, 216, 218, 219) where the steered current switched IQ summer amplifier can provide over 60 dB power control range.

### STATEMENT REGARDING FEDERALLY SPONSORED RESEARCH OR DEVELOPMENT

The United States Government supported research related to the invention and has certain rights herein.

### FIELD OF THE INVENTION

This invention relates generally to transmitters, and more particularly to method and system for efficient dynamic range power control used with transmitters.

### BACKGROUND OF THE INVENTION

The ability to have over 70 dB of power control range in an Radio Frequency (RF) lineup in practicality is very difficult due to isolation requirements, the amount of current required and linearity requirements. To obtain the required power control range and the appropriate isolation usually means the use of several stages in a lineup each consuming current or contributing to path loss and creating noise and non-linearities. Furthermore, maintaining a required or substantial signal linearity at all attenuation settings in a current efficient manner is also quite difficult for such a wide power control range. CDMA, WCDMA and other Direct Sequence Spread Spectrum systems require large power control ranges (+70 dB) with relatively high carrier suppression specifications. More frequently, cellular phones are now including multi-band operation requiring such large power control ranges.

Existing systems fail to provide such large power control ranges without sacrificing one or more among isolation, linearity and current efficiency. Known transmitter lineups typically use higher current and part counts and usually provide at least a part of their power control range at baseband frequencies which creates many of the suppression problems indicated above. Furthermore, known systems fail to provide the full power control range all at RF frequencies with a current efficient way of controlling power out in conjunction with a continuous power control range. Also, existing transmitter lineups fail to address the tradeoffs between distortion and current drain.

### SUMMARY OF THE INVENTION

In a first embodiment of the present invention, a system for current efficient dynamic power range control in a transmitter lineup can include a switched mixer coupled to a switched step attenuator and a switched power driver coupled to the switched step attenuator. In such a system, linearity and efficiency can be substantially maintained for more than 70 dB of dynamic power range for the system. The dynamic power range control can all occur within the radio frequency range and current can be dynamically switched along with the output power. In one particular embodiment, the transmitter allows for over 30 dB of continuous power control and over 45 dB of discrete power control at a predetermined number of dB steps. The switched mixer and the switched step attenuator can be FET based and the system can be fully integrated in CMOS circuitry or bipolar circuitry. The switched power driver can further include continuous power control via current steering and more specifically the switched power driver can be a combination stacked current steer and a current switched IQ summer amplifier where the current switched IQ summer amplifier can provide over 60 dB power control range. The switched power driver can also include a parallel gain driver providing relatively wide bandwidth.

In a second embodiment of the present invention, a system of current efficient dynamic power range control in a transmitter lineup can include means for providing over 70 dB of power control range in the transmitter lineup, means for maintaining substantial signal linearity and current efficiency throughout a complete power control range, and means for minimizing distortion by distributing distortion effects over a plurality of components in the transmitter lineup. The plurality of components can be at least one among a baseband driver, a mixer, a step attenuator, and an output driver. The means for providing over 70 dB power control range can include means for over 30 dB of continuous power control and over 45 dB of discrete power control at 5 dB steps. The means for maintaining substantial signal linearity throughout the complete power control range can include means for maintaining substantial signal linearity through all attenuation settings. The system can further include means of mitigating sideband splatter during a turn on and a turn off of the transmitter lineup by using a continuous ramping function and can further include a means of suppressing carrier signals.

In a third embodiment of the present invention, a method of current efficient dynamic power range control in a transmitter lineup can include the steps of providing over 70 dB of power control range in the transmitter lineup, maintaining substantial signal linearity and current efficiency throughout a complete power control range (such as by maintaining substantial signal linearity through all attenuation settings), and minimizing distortion by distributing distortion effects over a plurality of components in the transmitter lineup. As noted before, the transmitter lineup can allow for over 30 dB of continuous power control and over 45 dB of discrete power control at a predetermined number of dB steps. The method can further include the step of mitigating sideband splatter during a turn on and a turn off of the transmitter lineup by using a continuous ramping function. Further note that carrier signals can be suppressed by maintaining most of the power control range in the RF sections of the transmitter lineup.

### BRIEF DESCRIPTION OF THE DRAWINGS

FIG. 1 is a block diagram of a transmitter lineup having a large dynamic power range that maintains current efficiency and linearity throughout the range in accordance with an embodiment of the present invention.

FIG. 2 is a block diagram of a portion of the transmitter lineup of FIG. 1 providing further details of a switch mixer and step attenuator in accordance with an embodiment of the present invention.

FIG. 3 is a model representation of the portion of the transmitter lineup of FIG. 2 in accordance with an embodiment of the present invention

FIG. 4 is a parallel distributed output driver with current steering in accordance with an embodiment of the present invention.

FIG. 5 is a flow chart illustrating a method of current efficient dynamic power range control in a transmitter lineup in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

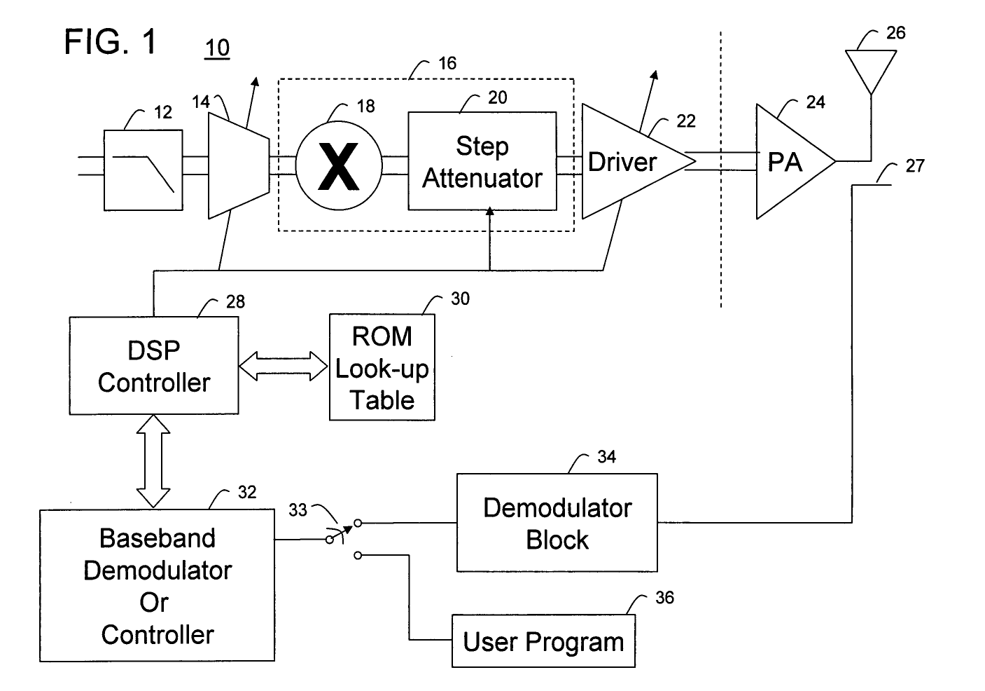

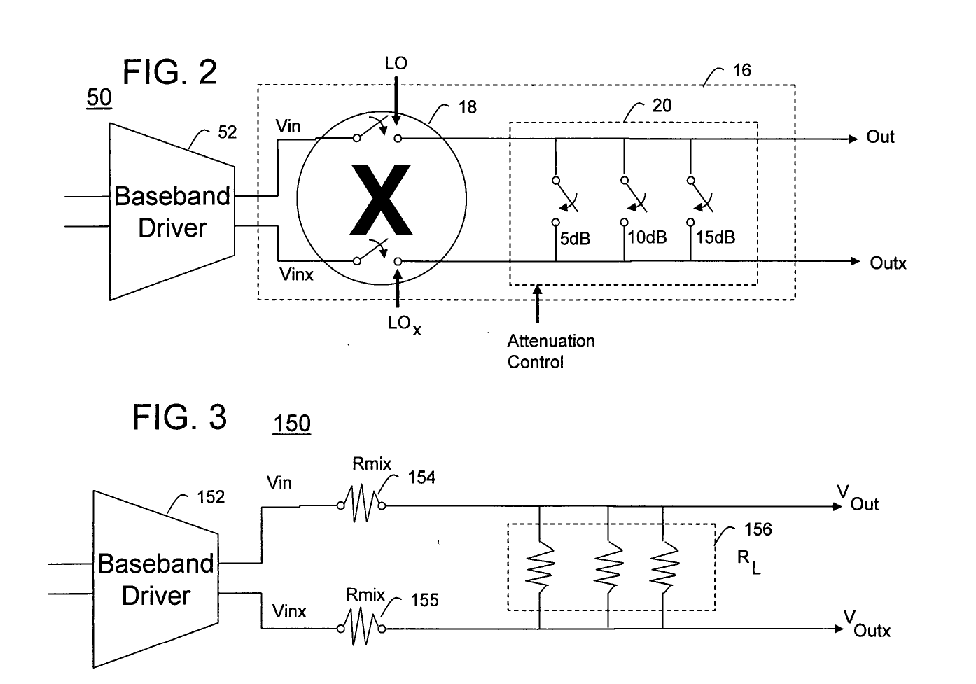

Referring to FIG. 1, a transmitter lineup 10 having at least 70 dB of power control range is shown. The transmitter lineup 10 can be fully integrated in an all CMOS embodiment or alternatively bipolar technology. The transmitter lineup 10 can include a baseband filter 12 receiving a baseband input and a current controlled baseband driver 14. The power control primarily occurs in two portions of the transmitter lineup, namely a voltage divider portion or circuit 16 and a current controlled output driver 22. The voltage divider circuit 16 is wide bandwidth since no resistors are used and thus no RC filtering is created by resistors used for the voltage divider. The voltage divider portion 16 can include a mixer 18 and a step attenuator 20 which will be further described with respect to FIGS. 2 and 3. The transmitter lineup 10 can be part of an overall transmitter system including a power amplifier 24 coupled to an antenna 26, a DSP controller 28 coupled to a ROM look-up table 30, a baseband demodulator or controller 32, a switch 33 and coupler 27 for selectively coupling a demodulator block 34 to the antenna for feedback, and a user program 36 which can control settings in the transmitter lineup 10 via the baseband demodulator/controller 32 and/or the DSP controller 28.

In one particular embodiment, the lineup 10 allows for over 30 dB (such as 35 dB or more) of continuous power control and over 45 dB of discrete power control at 5 dB steps for 80 dB or more of overall power control. This arrangement enables the use of a continuous ramping function to mitigate sideband splatter during a turn on and a turn off of the transmitter. Referring to FIG. 2, an RF lineup portion 50 can comprise a baseband driver 52 followed by a voltage divider circuit 16. The voltage divider can include an FET based quadrature switched mixer 18 followed by a FET based switched step attenuator 20. Referring to FIG. 3, the voltage divider 16 can be modeled using the circuit 150 with the baseband driver 152 providing complementary input voltages Vin and Vinₓ, the mixer represented by Rmix (resistors 154 and 155), and the attenuator 156 represented by the parallel load R_{L}. Thus, the output voltage of the voltage divider can be represented as the following:
Vout=Vin(R_{L}/(R_{L}+Rmix))
or
Voutₓ=Vinₓ(R_{L}/(R_{L}+Rmix))

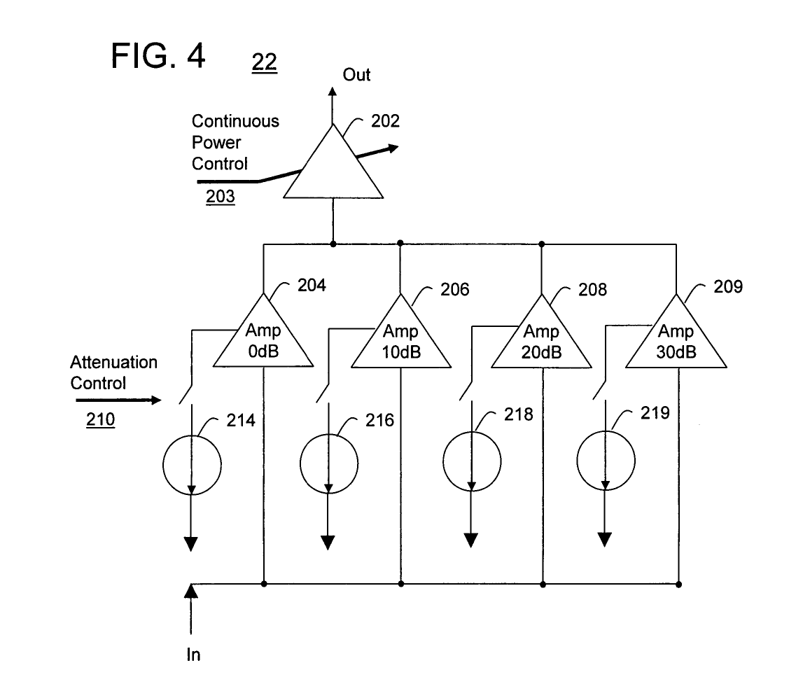

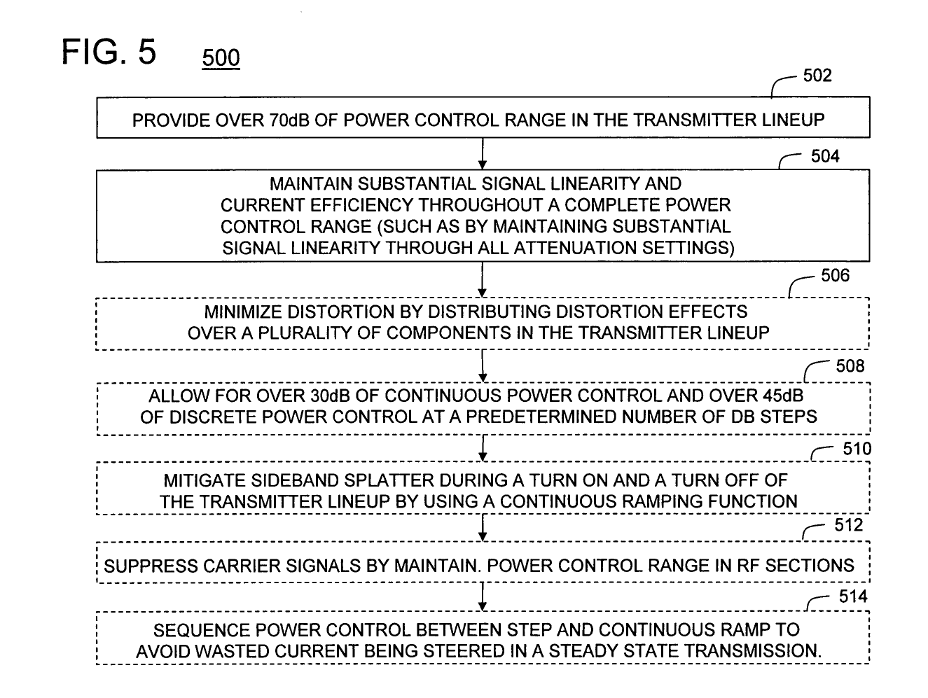

The voltage divider circuit 16 can then be followed by a distributed switched power driver 22 as shown in FIG. 4 which also incorporates continuous power control via current steering. The FET switched step attenuator 20 works in conjunction with the FET switched mixer 18 to provide 5, 10, 15 dB attenuation steps by creating the FET based voltage divider circuit 16 with very large bandwidths. The mixer 18 has switches that are controlled by complementary local oscillator signals LO and LOx. The attenuation steps in the switched step attenuator 20 are controlled by an attenuation control signal that can be provided by the DSP controller 28 (see FIG. 1). Referring once again to FIG. 4, the output driver 22 uses a combination stacked current steer 202 (controlled by continuous power control signal 203) and current switched IQ summer amplifier (204, 206, 208, 209, 214, 216, 218 and 219) with over 60 dB power control range. The current switched IQ summer amplifier is controlled by an attenuation control signal 210. These two blocks allow for a current efficient means of controlling output power while not degrading linearity. Note, although a summing embodiment is illustrated, non-summing embodiments are likewise contemplated within the scope of the present invention. Thus, if an embodiment has a stacked current steer with about 35 dB of continuous power control, a switched amplifier with at total of 30 dB of stepped power control (in stepped increments of 10 dB), and a voltage divider with a stepped 15 dB of power control (in 5 dB increments), then 80 dB (or more) of overall dynamic power control can be had in a transmitter lineup. Also, note that with current steering, the current steer 202 can command the current steered into the supply (In) or the load (out). The current steer enables the scaling of power in a continuous smooth fashion (not stepped).

Note, having this power control in a transmitter lineup in the RF section allows for a more relaxed absolute carrier suppression specification when dealing with a Cartesian (IQ) modulator design. Although having little power control range allocated to the baseband sections of a transmitter lineup and thus having most of the power control range allocated to the RF blocks can complicate a design, a full quadrature fully differential system will provide good isolation and suppression characteristics. Additionally, the system inherently distributes it's distortion effects on the processed signal over it's individual components in such a manner that the overall distortion is minimized.

The use of a FET based mixer/attenuator approach along with a parallel distributed gain driver 22 (as shown in FIG. 4) allows for a relatively wide bandwidth (6 GHz) with an all CMOS implementation of a current switched TX power control lineup. The complete system can operate to produce a desired output level with the least amount of required current in such a way that linearity is maintained thru the complete power control range.

Although the embodiments described herein are ideally suited for direct launch transmitters where the baseband is mixed-up to RF in one mix without an intermediate frequency (IF), even non-direct launch transmitters (using IF) can benefit from the concepts claimed herein. Note though that direct launch transmitters will likely cost less, use less area and have better current drain characteristics.

A method 500 of current efficient dynamic power range control in a transmitter lineup can include the step 502 of providing over 70 dB of power control range in the transmitter lineup, maintaining substantial signal linearity and current efficiency throughout a complete power control range (such as by maintaining substantial signal linearity through all attenuation settings) at step 504, and minimizing distortion at step 506 by distributing distortion effects over a plurality of components in the transmitter lineup. Note that the baseband amplifier current drive can also be scaled based on an attenuator setting. As noted before, the transmitter lineup can allow for over 30 dB of continuous power control and over 45 dB of discrete power control at a predetermined number of dB steps as noted at step 508. The method can further include the step 510 of mitigating sideband splatter during a turn on and a turn off of the transmitter lineup by using a continuous ramping function and the step 512 of suppressing carrier signals.

Thus, a given power level can be achieved using a combination of stepped and continuous control. In one embodiment, the stepped control is current efficient while continuous attenuation is used only during ramping so as not to waste any current. In this regard as shown at step 514, the power control can be sequenced between step and continuous ramping to avoid wasted current being steered off of ground or supply (which is wasteful) in a steady state condition or transmission.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A system for current efficient dynamic power range control in a transmitter lineup, comprising:
a switched mixer coupled to a switched step attenuator; and
a switched power driver coupled to the switched step attenuator, wherein linearity and efficiency is substantially maintained for more than 70 dB of dynamic power range for the system.

2. The system of claim 1, wherein the switched mixer and the switched step attenuator are FET based.

3. The system of claim 1, wherein the switched power driver further comprises continuous power control via current steering.

4. The system of claim 1, wherein the system is fully integrated in at least one among CMOS circuitry and bipolar circuitry.

5. The system of claim 1, wherein the switched power driver further comprises a combination stacked current steer and a current switched IQ summer amplifier.

6. The system of claim 5, wherein the current switched IQ summer amplifier provides over 60 dB power control range.

7. The system of claim 1, wherein the switched power driver further comprises a parallel gain driver providing relatively wide bandwidth.

8. The system of claim 1, wherein the transmitter allows for over 30 dB of continuous power control and over 45 dB of discrete power control at a predetermined number of dB steps.

9. The system of claim 1, wherein the dynamic power range control all occurs within the radio frequency range and current is dynamically switch along with the output power.

10. A method of current efficient dynamic power range control in a transmitter lineup, comprising the steps of:
providing over 70 dB of power control range in the transmitter lineup;
maintaining substantial signal linearity and current efficiency throughout a complete power control range; and
minimizing distortion by distributing distortion effects over a plurality of components in the transmitter lineup.

11. The method of claim 10, wherein the transmitter lineup allows for over 30 dB of continuous power control and over 45 dB of discrete power control at a predetermined number of dB steps.

12. The method of claim 10, wherein the step of maintaining substantial signal linearity throughout the complete power control range comprises maintaining substantial signal linearity through all attenuation settings.

13. The method of claim 10, wherein the method further comprises the step of mitigating sideband splatter during a turn on and a turn off of the transmitter lineup by using a continuous ramping function.

14. The method of claim 10, wherein the method further comprises the step of suppressing carrier signals.

15. A system of current efficient dynamic power range control in a transmitter lineup, comprising:
means for providing over 70 dB of power control range in the transmitter lineup;
means for maintaining substantial signal linearity and current efficiency throughout a complete power control range; and
means for minimizing distortion by distributing distortion effects over a plurality of components in the transmitter lineup.

16. The system of claim 15, wherein the transmitter lineup includes means for over 30 dB of continuous power control and over 45 dB of discrete power control at 5 dB steps.

17. The system of claim 15, wherein the means for maintaining substantial signal linearity throughout the complete power control range comprises means for maintaining substantial signal linearity through all attenuation settings.

18. The system of claim 15, wherein the system further comprises means of mitigating sideband splatter during turn on and turn off of the transmitter lineup by using a continuous ramping function.

19. The system of claim 15, wherein the system further comprises a means of sequencing power control between step and continuous ramping to avoid wasted current being steered off of supply or ground in a steady state condition.

20. The system of claim 15, wherein the plurality of components comprises at least one among a baseband driver, a mixer, a step attenuator, and an output driver.
